(19) United States
(12) Patent Application Publication
(10) Pub. No.: US 2013/0133631 A1
(43) Pub. Date: May 30, 2013

(54) SYSTEM TO MEASURE PARAMETERS OF A PARTICULATE LADEN FLOW

(71) Applicant: Russell Robert GRAZE, JR., Dunlap, IL (US)

(72) Inventor: Russell Robert GRAZE, JR., Dunlap, IL (US)

(73) Assignee: Caterpillar Inc.

(21) Appl. No.: 13/308,113

(22) Filed: Nov. 30, 2011

(51) Int. Cl. F02M 25/07; G01M 15/10

(52) U.S. Cl. 123/568.11; 73/23.33

(57) ABSTRACT

A system to measure a parameter of a particulate laden gas flow may include a conduit enclosed by a boundary wall directing the particulate laden gas flow and a sensor configured to measure the parameter. The system may also include an annular averaging chamber extending radially outwardly from the conduit. The averaging chamber may be positioned such that the sensor is fluidly coupled to the conduit through the averaging chamber. The system may further include a porous element extending around the conduit. The porous element may be positioned such that the averaging chamber is fluidly coupled to the conduit through the porous element.

### TECHNICAL FIELD

The present disclosure relates to a system to measure the parameters of a gas flow including particulate matter.

### BACKGROUND

In some applications, there is a need to measure parameters (such as, for example, pressure, velocity, mass flow rate, etc.) of a gaseous flow stream containing particulate matter (such as, for example, soot, etc.) in a real-time manner. The particulate matter in the flow stream, however, tends to settle and negatively impact the parameter measurements. For example, in an engine application where a pressure transducer is used to measure the time varying (or transient) pressure of exhaust flowing through a venturi, particulate matter in the exhaust (collectively referred to herein as soot) may impact the pressure measurements.

Published U.S. Patent Application No. 2009/0084193 to Cerabone et al. (“the '193 application”) discloses an apparatus for measuring an exhaust gas recirculation flow of an internal combustion engine. The apparatus of the '193 application includes a venturi pipe through which the recirculated exhaust gas flows. The apparatus further includes a differential pressure sensor that is in fluid communication with the venturi pipe through passages that connect to the venturi pipe. Although the '193 application discloses an apparatus that purportedly serves to measure the mass flow of exhaust through the venturi, in some cases particulate matter may collect in the passages that couple the pressure sensor to the venturi pipe, and eventually clog these passages.

The systems and methods of the present disclosure may help address the foregoing problems and/or other problems existing in the art.

### SUMMARY

In one aspect, a system to measure a parameter of a particulate laden gas flow is disclosed. The system may include a conduit enclosed by a boundary wall directing the particulate laden gas flow and a sensor configured to measure the parameter. The system may also include an annular averaging chamber extending radially outwardly from the conduit. The averaging chamber may be positioned such that the sensor is fluidly coupled to the conduit through the averaging chamber. The system may further include a porous element extending around the conduit. The porous element may be positioned such that the averaging chamber is fluidly coupled to the conduit through the porous element.

In another aspect, a method of measuring a parameter of a particulate laden gas flow is disclosed. The method may include directing the particulate laden gas through a conduit and detecting a signal indicative of the parameter using a sensor. The sensor may be fluidly coupled to the conduit through an averaging chamber and a porous element. The averaging chamber may be an annular chamber that extends radially outwardly from the conduit and is positioned such that the sensor is fluidly coupled to the conduit through the averaging chamber, and the averaging chamber is fluidly coupled to the conduit through the porous element.

In yet another aspect, an exhaust gas recirculation system of an engine is disclosed. The system may include a venturi tube configured to direct exhaust gas containing particulate matter therethrough. The system may also include a hollow cylindrical porous element extending around a portion of the venturi tube and a pressure sensor fluidly coupled to the venturi tube through the porous element.

### BRIEF DESCRIPTION OF THE DRAWINGS

FIG. 1 graphically illustrates an exemplary engine with an exhaust gas recirculation (EGR) system;

FIG. 2 is a cross-sectional view of an embodiment of a venturi tube that may be used in the EGR system of FIG. 1;

FIG. 3A is a perspective view of an exemplary channel member that may be used with the venturi tube of FIG. 2;

FIG. 3B is a cross-sectional view of the channel member of FIG. 3A;

FIG. 3C is a cross-sectional view of another embodiment of a channel member that may be used with the venturi tube of FIG. 2;

FIG. 4A is an enlarged view of a region of the venturi tube of FIG. 2 showing an embodiment of a filter element disposed therein;

FIG. 4B is perspective view of the filter element of FIG. 4A;

FIG. 5 graphically illustrates a low pass pneumatic filter of the venturi tube of FIG. 2.

### DETAILED DESCRIPTION

Although the systems and methods described herein are broadly applicable to the measurement of any parameter of a particulate laden gas flow in any application, for the sake of brevity, these concepts will be described with reference to an exhaust gas recirculation system of an engine.

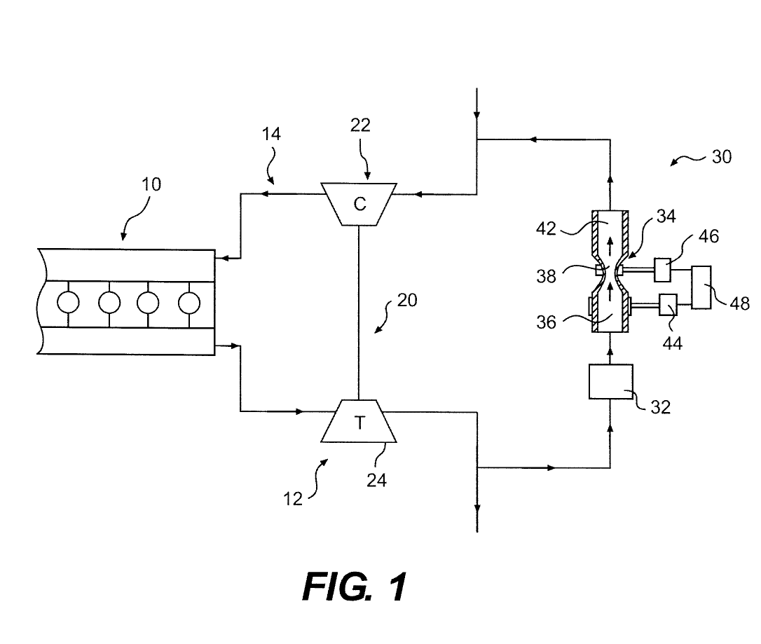

FIG. 1 illustrates an engine 10 with an exhaust gas recirculation (EGR) system 30 according to the present disclosure. Engine 10 may be any type of engine configured to produce power by combusting a fuel (such as, for example, diesel fuel, gasoline, etc.). Engine 10 may have one or more combustion chambers that combust the fuel and produce exhaust. Engine 10 may include an intake system 14 for delivering air and/or other gases to the combustion chambers and an exhaust system 12 for directing the exhaust gases away from combustion chambers. Intake system 14 may include various components for directing intake air (and/or other gases) into the combustion chambers. For example, intake system 14 may include, among other components, a compressor 22 of a turbocharger 20 configured to compress the intake air. Although not illustrated in FIG. 1, intake system 14 may include various other components that may assist in directing the intake air to the combustion chambers (such as, for example, valves, compressors, filters, heat exchangers, etc.). Exhaust system 12 may include various components configured to extract energy from the exhaust gases (exhaust) and direct the exhaust away from the engine 10. For example, exhaust system 12 may include a turbine 24 of turbocharger 20. Turbine 24 may be powered by the exhaust and operate the compressor 22. Exhaust system 12 may also include an aftertreatment system (not shown) configured to reduce the amount of undesirable constituents in the exhaust emitted by the engine 10.

EGR system 30 may direct some of the exhaust from the exhaust system 12 to mix with air passing through the intake system 14. EGR system 30 may include several components configured to treat and measure the recirculated exhaust before being directed to the intake system 14. These components may include, among others, an EGR cooler 32 and a venturi tube 34. The EGR cooler 32 may include any component (such as, for example, a heat exchanger) configured to cool the exhaust passing therethrough. The venturi tube 34 may be configured to measure the exhaust flow through the EGR system 30. Although FIG. 1 illustrates the exhaust as being drawn from the exhaust system 12 downstream of the turbine 24 and directed to the intake system 14 upstream of the compressor 22, this is only exemplary. In other embodiments, EGR system 30 may fluidly couple the exhaust system 12 to the intake system 14 at other locations. In addition to the components shown in FIG. 1, EGR system 30 may include various other components, including, but not limited to, valves, filters, mixers, etc., and these components may be arranged in any order relative to one another.

It is known that the mass flow rate of a fluid flowing through a pipe may be measured using a venturi tube. A venturi tube measures the mass flow rate by making use of the Venturi effect. The Venturi effect is the reduction in fluid pressure that results when a fluid flows through a constricted section of a pipe. By measuring the pressure of the fluid at the inlet and at the constricted section (that is, the pressure drop of the fluid), the flow rate can be calculated based on the law of conservation of energy and the Bernoulli theorem. Venturi tube 34 includes a constricted section (throat 38) positioned between an inlet 36 and an outlet 42. The exhaust in EGR system 30 enters venturi tube 34 through the inlet 36, flows through the throat 38, and exits the venturi tube 34 through the outlet 42. As the exhaust flows through the throat 38, the velocity of the exhaust increases at the expense of its pressure. Pressure sensors 44, 46, fluidly coupled to the inlet 36 and the throat 38, respectively, measure the pressure of the exhaust flowing through the inlet 36 and the throat 38. Based on the measured pressure, a controller 48 (in electrical communication with the pressure sensors 44, 46) may determine the pressure drop and the mass flow rate of exhaust flowing through the venturi tube 34.

Pressure sensors 44 and 44 may be any device configured to measure the pressure of a gas. Although two separate pressure sensors 44 and 46 are described as being coupled to the inlet 36 and the throat 38, this is only exemplary and other configurations (such as, for example, a differential pressure sensor coupled to the inlet and the throat, etc.) may be used to measure the pressure drop of the exhaust at the throat 38. Further, although not illustrated in FIG. 1, EGR system 30 may also include other components, such as, for example, a valve (in communication with the controller 48) configured to control the amount of exhaust redirected through the EGR system 30 based on the measured mass flow rate and/or other engine parameters.

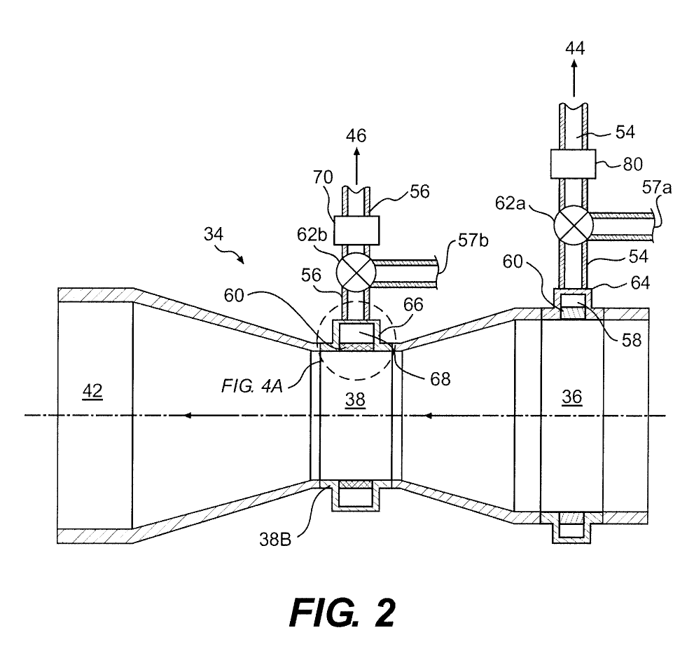

Any type of venturi tube known in the art may be used to measure the mass flow rate of exhaust flowing through EGR system 30. FIG. 2 illustrates an embodiment of the venturi tube 34 that may be used in EGR system 30. Venturi tube 34 includes a tubular structure with a throat 38, having a reduced diameter, positioned between the inlet 36 and the outlet 42. The diameter of the inlet 36, the throat 38, and the outlet 42 may be any value and may be selected based on the application. A passageway 54 may fluidly couple the inlet 36 to pressure sensor 44 (see FIG. 1), and a passageway 56 may fluidly couple the throat 38 to pressure sensor 46. As the exhaust flows through the venturi tube 34, the passageways 54 and 56 transmit the pressure of the exhaust to the pressure sensors 44 and 46. The pressure sensors 44, 46 are thus exposed to the pressure proximate the opening of the passageways 54, 56 into the venturi tube 34. For example, pressure sensor 46 is exposed to (and therefore measures) the pressure of the exhaust flowing around the opening of passageway 56 into the throat 38.

It is known that flow discontinuities (such as, for example, bends and other flow disruption features that disturb the flow of a fluid) at an upstream location change the characteristics of fluid flow for a finite distance downstream of the discontinuity. This finite distance is typically expressed as a ratio of the length of pipe to the diameter (L/D ratio) of the pipe. That is, a discontinuity in the exhaust stream upstream of passageway 56 affects the characteristics of exhaust flow across the throat 38. Therefore, the pressure (and other characteristics) of the exhaust at all locations along the diameter, or at all locations along the circumference, of the throat 38 may not be the same. To ensure that the pressure measured by pressure sensor 46 is a true representation of the pressure of the exhaust at the throat 38, the passageway 56 is coupled to the throat 38 through an averaging chamber 68.

Averaging chamber 68 is an annular chamber formed around throat 38, and positioned between the passageway 56 and the throat 38. Coupling the pressure sensor 46 to the throat 38 through an averaging chamber 68 (annularly disposed around the throat 38) exposes the pressure sensor 46 to an average pressure in the throat 38. If the pressure distribution of the exhaust in throat 38 is non-uniform due to an upstream flow discontinuity (or due to any other reason), the averaging chamber 68 averages (or assists in averaging) the pressure of the exhaust in the throat 38. Thus, pressure sensor 46 measures an average pressure of the exhaust in the throat 38. The size of the averaging chamber 68 depends on the application. The factors that may play a role in the size of the averaging chamber 68 may include, among others, the expected exhaust pressure, expected pressure variation around the throat 38, frequency of the pressure transient, etc. For example, in an application where the variation in pressure around the throat 38 is high, a relatively larger averaging chamber 68 may be provided. In an application where the pressure of the exhaust through the throat 38 changes relatively fast with time, the size of the averaging chamber 68 may be relatively smaller to ensure that the pressure sensor 46 measures the transient characteristics of the exhaust pressure at the throat 38. A large averaging chamber 68 in such an application may act as a filter that filters the high frequency pressure pulses passing therethrough. In some embodiments, the size of the averaging chamber 68 may be selected to ensure sufficient averaging of the pressure without filtering the transient pressure pulses. In some embodiments, a vibration damping packing material may be disposed inside the averaging chamber 68. The averaging chamber 68 may be formed by attaching a channel member 66 to the throat 38.

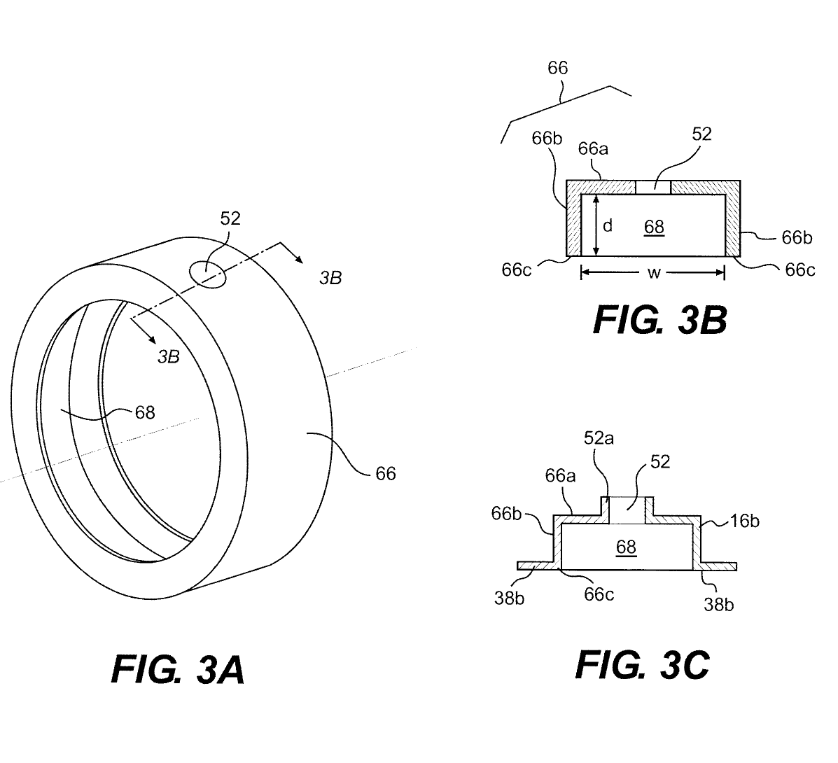

FIG. 3A illustrates a perspective view of an exemplary channel member 66 that may be attached to the throat to form the averaging chamber 68. FIG. 3B illustrates a cross-sectional view of the channel member 66 along plane 3B. In the description that follows, reference will be made to both FIGS. 3A and 3B. Channel member 66 may be a ring shaped element having a generally C-shaped cross-sectional shape. Channel member 66 may include a base section 66a with two legs 66b that extend from either end of the base section 66a. Although not a requirement, in some embodiments, as illustrated in FIG. 3B, the legs 66b may extend substantially perpendicular to the base section 66a. The channel member 66 may be attached to the venturi tube 34 at terminal ends 66c of the legs 66b. The channel member 66 may be attached to the venturi tube 34 by any method (welding, brazing, adhesive attach, etc.) suitable for the operating environment of the venturi tube 34. The base section 66a may include an opening 52 to engage with the passageway 56 coupled to the pressure sensor 46. In some embodiments, more than one opening 52 may be provided in the base section 66a. In these embodiments, multiple passageways may couple the averaging chamber 68 to the pressure sensor 46. For example, in some embodiments, channel member 66 may include two openings 52 (that are separated by, for example, 90°), and a passageway 56 having a Y-configuration may couple to the two openings 52 at one end and to the pressure sensor 46 at the opposite end. Multiple openings 52 positioned around the base section 66a may assist in averaging the pressure around the throat 38. In an application where the size of the averaging chamber 68 is selected to be small to prevent filtering of pressure pulses, multiple openings 52 may provide the desired averaging.

Although a channel member 66 having a generally C-shaped cross-sectional shape is illustrated in FIG. 3B, in general, the channel member 66 may have any shape that forms an averaging chamber 68 around throat 38. The channel member 66 may also have any size. The size of the channel member 66 may depend on the desired size of the averaging chamber 68. In some embodiments, the depth (d) of the averaging chamber 68 may vary from between about 1-10 mm and its width (w) may vary between about 10-50 mm. The channel member 66 may be formed by any material. In some embodiments, the material of the venturi tube 34 and the channel member 66 may be the same to minimize the coefficient of thermal expansion (CTE) mismatch induced stresses in the weld (or other attachment medium) between the two components. In some embodiments, the passageway 56 may also be made of a material having a similar CTE to reduce CTE mismatch induced stresses. In some embodiments, the channel member 66 may be configured to form the throat 38 of the venturi tube 34. FIG. 3C illustrates a cross-sectional view of another exemplary embodiment of channel member 166 in which the ends of the legs 66b, opposite the base 66a, extend substantially perpendicularly from the legs 66b to form the walls 38b of the throat 38. A coupling 52a may also be provided at opening 52 to enable of coupling of passageway 56 to channel member 166.

With reference to FIG. 2, as exhaust in EGR system 30 flows through the venturi tube 34, soot in the exhaust may settle on the walls of the venturi tube 34. This settling of the soot may be caused by known mechanisms such as thermophoresis (in which soot migrates towards the lower temperature walls), pressure pulses acting as a pneumatic hammer (caused by repeated opening and closing of the exhaust valve), etc. The soot settling on the walls of the venturi tube 34 may clog the passageways 54, 56 and thereby impact the measurement of pressure by the pressure sensors (or any other sensor) coupled to these passageways. Thus, the soot in the exhaust may impact the measurement of exhaust pressure. To minimize this impact, a porous element or a filter element 60 may be positioned between the averaging chamber 68 and the throat 38.

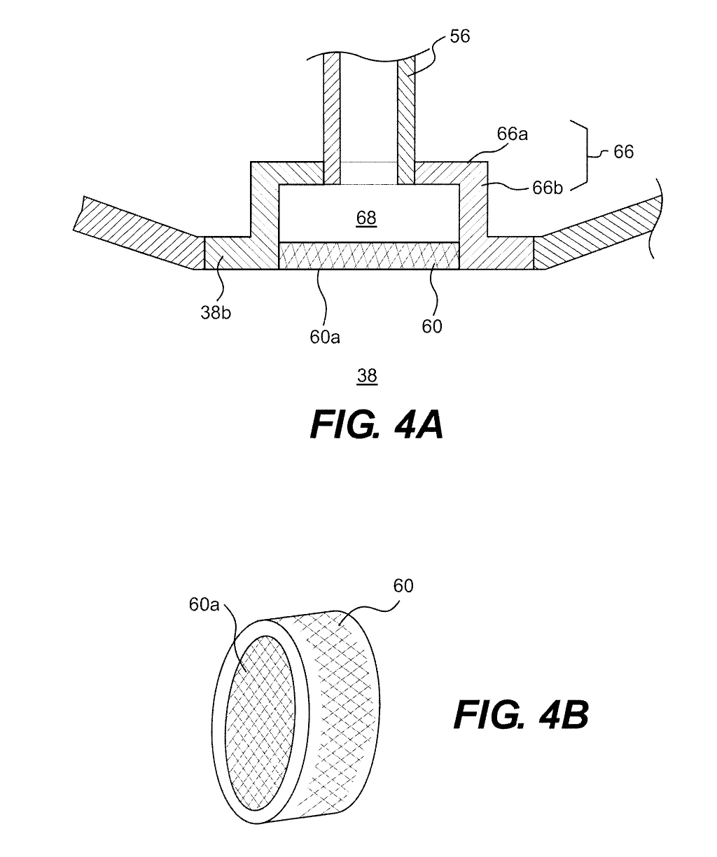

FIG. 4A illustrates an enlarged view of the averaging chamber 68 (location identified in FIG. 2) showing the filter element 60 positioned between the averaging chamber 68 and the throat 38. Filter element 60 may include a porous material coupled to the channel member 66 such that the pores of the filter element 60 fluidly couple the throat 38 to the averaging chamber 68. In some embodiments, the filter element 60 is coupled to the channel member 66 such that a surface 60a of the filter element 60 exposed to the throat 38 is substantially flush with the walls 38b of the throat 38. Positioning the surface 60a substantially flush with the walls 38b may ensure that the filter element 60 does not affect the exhaust flow pattern (and thereby the pressure distribution) in the throat 38. The filter element 60 may be coupled to the channel member 66 by any method. In some embodiments, the filter element 60 may be positioned such that it spans across substantially the entire opening of the averaging chamber 60 into the throat 38. In such embodiments, substantially all the exhaust that enters the averaging chamber 60 from the throat 38 passes through the filter element 60. In some embodiments, the filter element 60 may be attached to the channel member 66 by welding, brazing, soldering, using a high temperature adhesive, etc. In some embodiments, the filter element 60 may be interference fitted to the channel member 66. Although not illustrated herein, in some embodiments, the legs 66b (for example, at the terminal ends 66c) of the channel member 66 may include a step or another feature to hold the filter element 60 substantially flush with the throat walls 38b. Although filter element 60 is described as being attached to the channel member 66, this is only exemplary. In some embodiments, the filter element 60 may be attached (welded, etc.) to the venturi tube 34, with the channel member 66 placed over the filter element 60 and attached to the venturi tube 34.

FIG. 4B illustrates a perspective view of the filter element 60. In some embodiments, the filter element 60 may have a hollow cylindrical shape. When installed in the channel member 66, the internal surface 60a of the cylindrical filter element 60 may form the walls of the throat 38. Although a cylindrically shaped filter element 60 is described herein, it should be noted that, in general, the filter element 60 can have any shape and configuration. For example, in an application without an averaging chamber 68, or in an application in which the averaging chamber 68 has a different shape, the filter element 60 may have a different shape. The filter element 60 may be made of any material and may have any pore size. The size of the pores may be selected to be small enough to block soot from passing therethrough while being large enough to transmit pressure therethrough. In general, the size of the pores may depend on the application. The factors that dictate the pore size may be similar to the factors that dictate the size of the averaging chamber 68. In general, for application in which increased flow stability is desired, a smaller pore size may be used, and in applications where dynamic response is desired, a filter element 60 with a larger pore size may be employed. In some embodiments, the pore size of the filter element 60 and the size of the averaging chamber 68 may be tuned to achieve desirable properties. In some embodiments, the filter element 60 may be made of sintered stainless steel with a pore size between about 10 and 50 microns, and have a total open area between about 30 and 50% of surface 60a.

With reference to FIG. 2, in some embodiments, 3-way valves 62a, 62b, fluidly coupled to purge lines 57a, 57b, may be provided in passageways 54, 56 downstream of averaging chambers 58, 68. The purge lines 57a, 57b may be coupled to a source of compressed air or another gas. In such embodiments, the 3-way valves 62a, 62b may be periodically activated to direct a burst of air (or another gas) into the passageways 54, 56 through the purge lines 57a, 57b. This burst of air may flow upstream through the passageways 54, 56 into the venturi tube 34 to clear the pores of the filter elements 60. These air burst may be of a relatively short duration (for instance, 1-3 seconds) and may occur at times when the pressure sensors 44, 46 are inactive. The air bursts may be especially suitable for applications where flow measurement times are separated by periods where there is no interest in flow measurement.

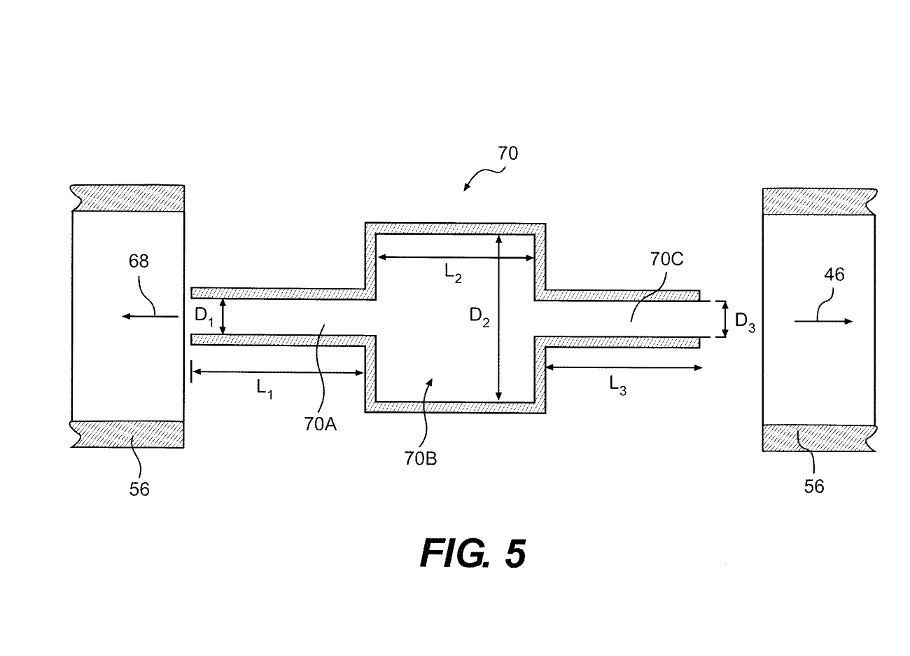

With reference to FIG. 2, in some embodiments, a low pass pneumatic filter 70 may be incorporated downstream of the averaging chamber 68 to minimize the exposure of the pressure sensor 46 to high frequency noise. FIG. 5 illustrates a pneumatic filter 70 that may be positioned between averaging chamber 68 and the pressure sensor 46. In some embodiments, the pneumatic filter 70 may be a part of the passageway 56, while in other embodiments, the pneumatic filter may be a separate part that is fluidly coupled to the passageway 56. The pneumatic filter 70 may include a tubular component with sections having different lengths and diameters. For instance, pneumatic filter 70 may include a first section 70a having a first length L₁ and a first diameter D₁, positioned upstream of a second section 70b having a larger second diameter D₂ and a second length L₂, and a third section 70c having a third diameter D₃ and a third length L₃ positioned downstream of the second section 70b. In some embodiments, the second diameter D₂ may be larger than the first and the third diameters D₁, D₃, and the second length L₂ may be smaller than the first and the third lengths L₁, L₃. In some embodiments, the second diameter D₂ may be smaller than the diameter of passageway 56. The relative dimensions of the first, second, and third sections 70a, 70b, 70c of the pneumatic filter 70 may be selected to block high frequency pulses (≧about 100 Hz) without affecting the low frequency pressure pulses (≦20 Hz) passing therethrough. While the exact dimensions of the different sections of the pneumatic filter 70 may vary with the particular application, in an exemplary application in an EGR system 30, the first and third diameters D₁, D₃ may be between about 1-2 mm, the first and third lengths L1, L3 were between about 10-15 mm, and the second diameter D₂ and second length L₂ may be between 3-7 mm and 5-8 mm respectively.

As illustrated in FIG. 2, in some embodiments, a channel member 64 may also be positioned annularly around the inlet 36 to form an averaging chamber 58 around the inlet 36. A filter element 60 may be positioned to fluidly couple the averaging chamber 58 to the inlet 36. In some embodiments, a pneumatic filter 80 may also be positioned downstream of the averaging chamber 58 to block high frequency pressure pulses from reaching the pressure sensor 44. Since the channel member 64, averaging chamber 58, and the pneumatic filter 80 function in a similar manner to the channel member 66, averaging chamber 68, and the pneumatic filter 70 discussed previously, for the sake of brevity, they are not described in more detail herein.

### INDUSTRIAL APPLICABILITY

The disclosed systems and methods to measure the parameters of a particulate laden gas flow may be used in any application where it is desired to measure the parameters of the gas flow. The disclosed system may be especially useful where it is desired to measure transient parameters of gas flow in a real-time manner. The disclosed system may promote accurate measurements of an average value of the parameter and may reduce the impact of the particulate matter in the measurements. To illustrate some of the novel aspects of the disclosed system, an application in an EGR system of an engine exhaust system is described below.

A portion of exhaust flowing through the exhaust system 12 of the engine may be re-directed to the intake system 14 through an EGR system 30. In EGR system 30, the exhaust may be passed through a venturi tube 34 to determine the mass flow rate of the re-directed exhaust. The venturi tube 34 determines the mass flow rate by measuring the pressure drop of the exhaust between two regions (the inlet 36 and the throat 38) of the venturi tube 34 using pressure sensors 44, 46. To measure an average value of the pressure at a region, the pressure sensors 44, 46 are fluidly coupled to the regions through averaging chambers 58, 68 which assist in averaging the pressure of the exhaust around a circumference of the region. To prevent particulate matter in the exhaust from entering and clogging the averaging chambers 58, 68, or the passageways 54, 56 to the pressure sensors 44, 46, a porous element 60 is provided at the entrance to the averaging chambers 58, 68. To minimize the impact of high frequency pressure pulses (or noise) on the pressure measurements, pneumatic filters 70, 80 are also provided between the pressure sensors 44, 46 and the averaging chambers 58, 68.

Averaging the pressure in a region using an averaging chamber 58, 68 may help ensure that a pressure sensor 44, 46 provides an accurate representation of the exhaust pressure in the region. Inhibiting the plugging of the passages 54 and 56 by particulate matter may help ensure that the pressure measured by the pressure sensors 44, 46 is accurate.

It will be apparent to those skilled in the art that various modifications and variations can be made in the disclosed systems and methods without departing from the scope of the disclosure. Other embodiments of the disclosed systems and methods will be apparent to those skilled in the art from consideration of the specification and practice of the systems and methods disclosed herein. It is intended that the specification and examples be considered as exemplary only, with a true scope of the disclosure being indicated by the following claims and their equivalents.

What is claimed is:

1. A system to measure a parameter of a particulate laden gas flow, comprising:
a conduit enclosed by a boundary wall directing the particulate laden gas flow;
a sensor configured to measure the parameter;
an annular averaging chamber extending radially outwardly from the conduit, the averaging chamber being positioned such that the sensor is fluidly coupled to the conduit through the averaging chamber; and
a porous element extending around the conduit, the porous element being positioned such that the averaging chamber is fluidly coupled to the conduit through the porous element.

2. The system of claim 1, wherein the porous element has a cylindrical shape and is positioned such that an inner cylindrical surface of the porous element is substantially flush with an inner surface of the boundary wall of the conduit.

3. The system of claim 1, wherein the sensor is fluidly coupled to the averaging chamber through a fluid passageway.

4. The system of claim 1, wherein the sensor is a pressure sensor.

5. The system of claim 1, further including a pneumatic filter positioned between the sensor and the averaging chamber.

6. The system of claim 1, further including a ring shaped channel member having a generally C-shaped cross-sectional shape that extends around the conduit to form the averaging chamber.

7. The system of claim 1, wherein the conduit is a part of an exhaust system of an engine.

8. The system of claim 7, wherein the porous element includes a pore size between about 10 and 50 microns and a total open area between about 30 and 50% of a surface of the porous element exposed to the gas flow.

9. The system of claim 1, wherein the averaging chamber is positioned to fluidly couple to the conduit at one end and fluidly couple to the sensor at an opposite end.

10. A method of measuring a parameter of a particulate laden gas flow, comprising:
directing the particulate laden gas through a conduit; and
detecting a signal indicative of the parameter using a sensor fluidly coupled to the conduit through an averaging chamber and a porous element, the averaging chamber being an annular chamber that extends radially outwardly from the conduit and is positioned such that, the sensor is fluidly coupled to the conduit through the averaging chamber, and the averaging chamber is fluidly coupled to the conduit through the porous element.

11. The method of claim 10, further including directing a purge gas into the conduit through the porous element.

12. The method of claim 11, wherein detecting a signal includes detecting a pressure of the exhaust.

13. The method of claim 10, further including averaging values of the parameter using the averaging chamber prior to detecting the signal.

14. The method of claim 10, further including filtering high frequency noise in the parameter using a pneumatic filter.

15. An exhaust gas recirculation system of an engine, comprising:
a venturi tube configured to direct exhaust gas containing particulate matter therethrough;
a hollow cylindrical porous element extending around a portion of the venturi tube; and
a pressure sensor fluidly coupled to the venturi tube through the porous element.

16. The exhaust gas recirculation system of claim 15, further including an averaging chamber fluidly coupling the pressure sensor and the venturi tube, the averaging chamber being an annular chamber that extends around the portion of the venturi tube.

17. The exhaust gas recirculation system of claim 15, further including a pneumatic filter fluidly coupling the sensor and the averaging chamber.

18. The exhaust gas recirculation system of claim 15, wherein the porous element is positioned such that an internal cylindrical surface of the porous element is substantially flush with an internal surface of the venturi tube.

19. The exhaust gas recirculation system of claim 15, wherein the porous element includes a pore size between about 10 and 50 microns and a total open area between about 30 and 50% of a surface of the porous element exposed to the gas flow.

20. The exhaust gas recirculation system of claim 19, wherein the porous element is made of sintered stainless steel.
